(19) United States
(12) Patent Application Publication
(10) Pub. No.: US 2012/0229320 A1
(43) Pub. Date: Sep. 13, 2012

(54) Nine-square virtual input system using a remote control

(75) Inventor: Siu-Leong Yu, Taipei City (TW)

(73) Assignee: Sunplus Technology Co., Ltd., Hsinchu (TW)

(21) Appl. No.: 13/137,272

(22) Filed: Aug. 3, 2011

(30) Foreign Application Priority Data
Mar. 11, 2011 (TW) 100108285

(51) Int. Cl. H04L 17/02

(52) U.S. Cl. 341/176

(57) ABSTRACT

A nine-square virtual input system includes a nine-square virtual keyboard having multiple subsidiary nine-square grids. There is a main-location subsidiary nine-square grid, and each subsidiary nine-square grid has virtual keys corresponding to predefined symbols or user options respectively. A display device displays the virtual keyboard. A remote control controls the display device and has an input function key, a set of direction keys, and a set of digit keys. By pressing the input function key, the display displays the virtual keyboard in an OSD manner. By pressing the set of direction keys, an input focus is moved among the subsidiary nine-square grids, and then by pressing the set of digit keys to select a virtual key, the predefined symbol or user option corresponding to the selected virtual key is inputted.

### CROSS REFERENCE TO RELATED APPLICATION

This application claims the benefits of the Taiwan Patent Application Serial Number 100108285, filed on Mar. 11, 2011, the subject matter of which is incorporated herein by reference.

### BACKGROUND OF THE INVENTION

1. Field of the Invention

The present invention relates to an input system and, more particularly, to a nine-square virtual input system using a remote control.

2. Description of Related Art

Digital electric appliances have the essential functions of information share, easy use, and personalization. For example, information products functioning as electric appliances, electric appliances functioning as information products, and application products providing personal operations and relaxations are regarded as a part of the digital electric appliances. Upon current development of digital electric appliances, the mainstream includes LCD TVs, set-top boxes, DVD players, and blue ray DVD players.

Since the digital electric appliances are generally placed in a living room to provide various entertainments, unlike personal computers are used in works, they do not connect with a keyboard and a mouse. Thus, a remote control, wireless keyboard, voice recognition, gesture recognition, a remote control with a touch screen, and the like are used as an input device in the digital electric appliances. However, such input devices on the digital electric appliances cannot satisfy the user requirements in cost, convenience, and easy learning.

All typical large-size multimedia displays (especially 30-inch and above) acting as televisions or monitors are desktop devices, which can connect with a personal computer to provide the functions of operation, document process, online access, or email receiving and sending. However, since the display has a large size, a user has to keep a distance at least 1.5 meter from the screen of a display for a comfortable viewing. When a personal computer connects a large-size display, the entire appearance is very disordered and complicated because the personal computer has various connected cables and peripherals, such as a display, VGA cable, speaker, sound cable, keyboard, mouse, power line, and the like. Therefore, it is desired to have a multimedia display and a personal computer combined in design. If a user desires to operate the multimedia display as a TV multimedia display, the multimedia display combined with the personal computer is typically controlled by a remote control. In operating the personal computer, a mouse is used to control a keyboard as an input device. As a result, two input devices are required, which causes an inconvenience in use. For example, U.S. Pat. No. 6,757,707 entitled “Displayed complementary content sources in a web-based TV system” granted to Houghton, et al. has disclosed a web-based TV system in which a remote keyboard and a remote control are used to input words and take a control, which may cause the inconvenience in use.

Accordingly, a typical approach is to use the operation of a control as the operation of the multimedia display of a television (i.e., a TV multimedia display) and as the operation of the multimedia display of a personal computer (i.e., a PC multimedia display) for proceeding online operations without requiring complex input. However, in operating online access, if it is required to input context, for example, in inquiring the timetable, the operation also becomes inconvenient.

Furthermore, another approach is to press an operation key of the input unit (remote control) in an interactive TV system to output a key code to a control unit for converting the key code into a computer keyboard code and sending the computer keyboard code to a browser to thereby achieve the effect of using the remote control to input the computer keyboard code. However, only one computer keyboard code (backspace or delete key) can be emulated because the remote control has only one operation key, resulting in difficulty in inputting arbitrary words. A further approach is to present a virtual keyboard on the screen of a display, to use up, down, left and right keys of the input unit (remote control) to move on the virtual keyboard, and to use an operation key to select a virtual key on the virtual keyboard thereby achieving the effect of inputting arbitrary words. However, such a way requires pressing the direction keys multiple times for inputting the desired words, which causes inconvenience in use as well.

Therefore, it is desirable to provide an improved nine-square virtual input system using a remote control to mitigate and/or obviate the aforementioned problems.

### SUMMARY OF THE INVENTION

The object of the present invention is to provide a nine-square virtual input system using a remote control, which is applied in a multimedia display to reduce the number of pressing the keys, so as to use the remote control for rapid input, thereby increasing the user-friendliness of a human-machine interface and the added value of a multimedia display.

To achieve the object, there is provided a nine-square virtual input system , comprising a nine-square virtual keyboard, a display device, and a remote control. The nine-square virtual keyboard includes multiple subsidiary nine-square grids, each having multiple virtual keys, one of the subsidiary nine-square grids being a main-location subsidiary nine-square grid. The display device is provided for displaying the nine-square virtual keyboard. The remote control has an input function key, a set of direction keys, and a set of selection keys for remotely controlling the display device, the set of selection keys having multiple keys arranged in a 3×3 matrix form for corresponding to the nine-square virtual keyboard. The nine-square virtual keyboard is displayed on the display device when the input function key is enabled. A virtual key of the main-location subsidiary nine-square grid is inputted by directly using the set of selection keys to select the virtual key of the main-location subsidiary nine-square grid. A virtual key of a desired one among the other subsidiary nine-square grids is inputted by using the set of direction keys to move to the desired subsidiary nine-square grid and using the set of selection keys to select the virtual key of the desired subsidiary nine-square grid, thereby inputting a predefined symbol or user option corresponding to the virtual key selected.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a nine-square virtual input system using a remote control according to a preferred embodiment of the invention;

FIG. 2 is a system block diagram according to a preferred embodiment of the invention;

FIG. 3 is a schematic view of a remote control according to a preferred embodiment of the invention;

FIG. 4 is a schematic view of a nine-square virtual keyboard according to a preferred embodiment of the invention;

FIG. 5 is a schematic view of another nine-square virtual keyboard according to a preferred embodiment of the invention;

FIGS. 6(A)-6(C) schematically illustrate of the display of the nine-square virtual keyboard according to a preferred embodiment of the invention;

FIGS. 7(A)-7(B) schematically illustrate the displayed location of the nine-square virtual keyboard according to a preferred embodiment of the invention; and

FIGS. 8(A)-8(C) schematically illustrate another nine-square virtual keyboard according to a preferred embodiment of the invention.

### DETAILED DESCRIPTION OF THE PREFERRED EMBODIMENT

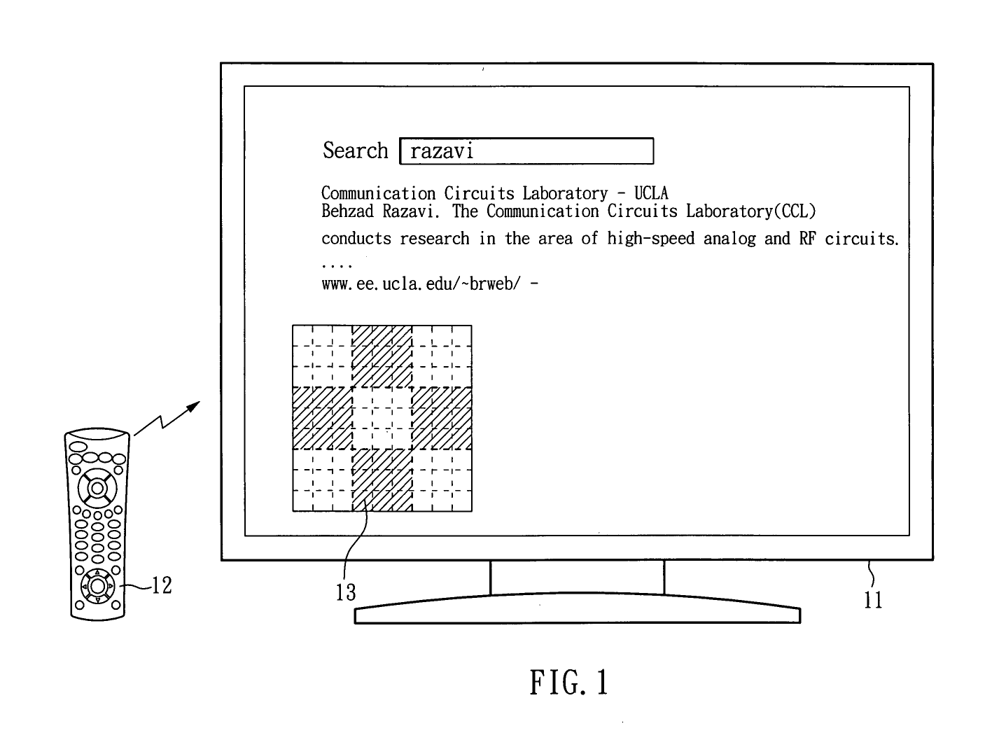

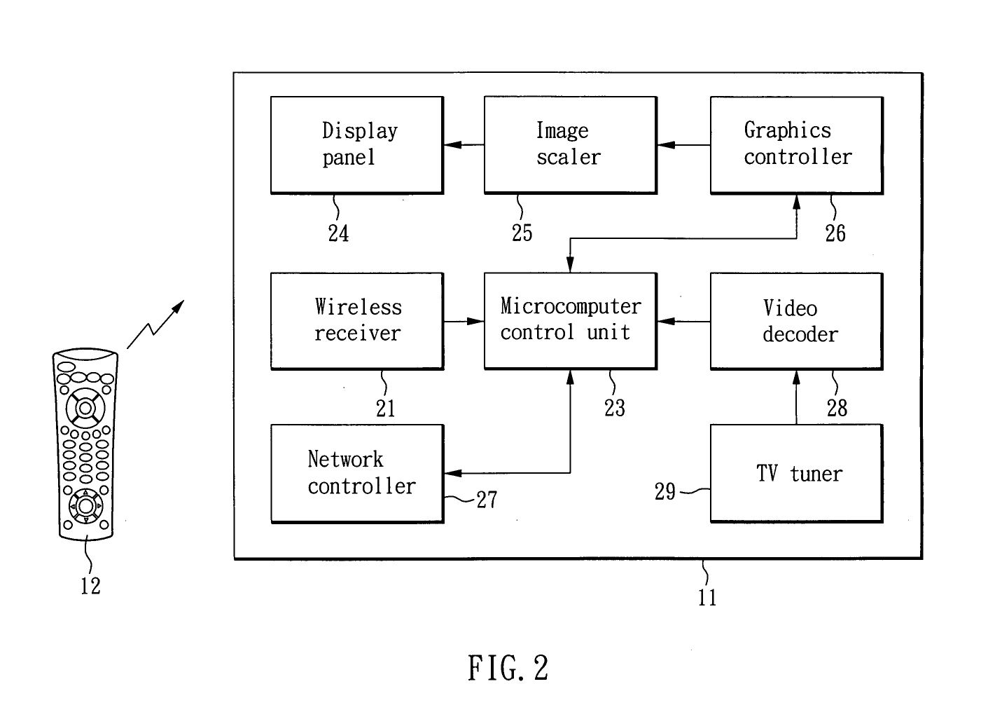

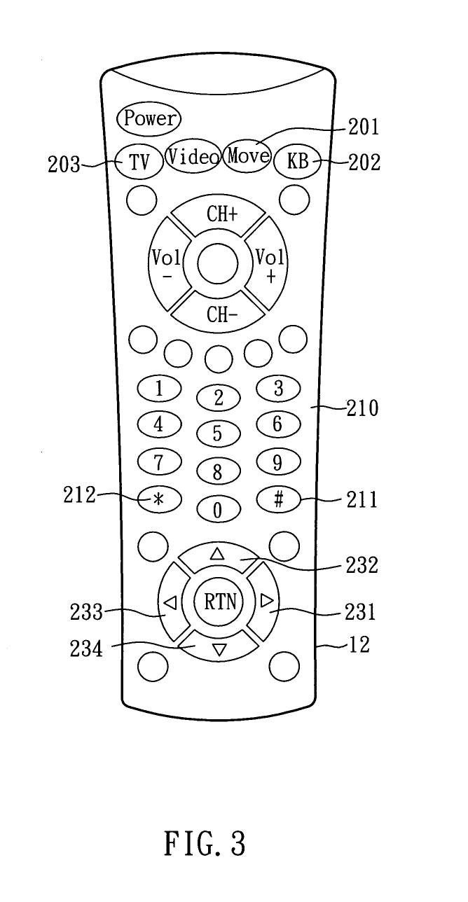

The invention relates to a nine-square virtual input system 100 using a remote control, which is applied in a multimedia display. FIG. 1 is a schematic view of the nine-square virtual input system 100 using a remote control according to a preferred embodiment of the invention. FIG. 2 is a system block diagram according to a preferred embodiment of the invention. FIG. 3 is a schematic view of a remote control according to a preferred embodiment of the invention. As shown in FIGS. 1-3, the system 100 includes a display device 11, a remote control 12, and a nine-square virtual keyboard 13.

As shown in FIGS. 1 and 2, the display device 11 includes a wireless receiver 21, a microcomputer control unit 23, a display panel 24, an image scaler 25, a graphics controller 26, a network controller 27, a TV tuner 29, and a video decoder 28. The display device 11 can be operated at various modes, such as a TV mode and a display mode. For operating in the TV mode, the display device 11 displays an input TV image through the display panel 24. For operating in the display mode, the network controller 27 performs a network connection and a network data operation processing, and the display panel 24 of the display device 11 displays the display output of webpage. The wireless receiver 21 receives commands generated from the remote control 12 in a wireless manner. The microcomputer control unit 23 is electrically connected to the wireless receiver 21, the graphics controller 26, the network controller 27, and the video decoder 28. The display panel 24 of the display device 11 is provided for displaying frame images of TV or webpage. The image scaler 25 scales the frame images for displaying, and also provides the function of on screen display (OSD). In addition, in the TV mode, the TV tuner 29 and the video decoder 28 are employed for allowing a user to select a desired TV channel. The microcomputer control unit 23 displays TV channels or graphics outputted by the TV tuner 29 on the display panel 24 through the graphics controller 26 and the image scaler 25. The microcomputer control unit 23 is also capable of performing an online access through the network controller 27.

The remote control 12 can remotely control the display device 12. As shown in FIG. 3, the remote control 12 includes a movement function key 201, an input function key 202, a TV key 203, a set of digit keys 210, a right direction key 231, an up direction key 232, a left direction key 233, and a down direction key 234. The set of digit keys 210 includes keys “1” to “9” arranged in a 3×3 matrix form. The system is switched between the TV mode and the display mode by pressing the TV function key 203 of the remote control 12. In other embodiments, the mode switching can be performed by pressing other keys. The movement function key 201 and the input function key 202 can be an option, i.e., physically provided on the remote control 12 or removed from the remote control 12. When the remote control 12 does not have the movement function key 201 and the input function key 202, the functions thereof can be achieved by other keys, or their combination, on the remote control.

When the display device 11 is operated at the display mode and an input such as a name “razavi” for online inquiring, as shown in FIG. 1, is required, the input function key 202 of the remote control 12 is pressed to display a nine-square virtual keyboard 13 on the display device 11 in an on-screen display (OSD) manner, and pressed again to close the nine-square virtual keyboard 13.

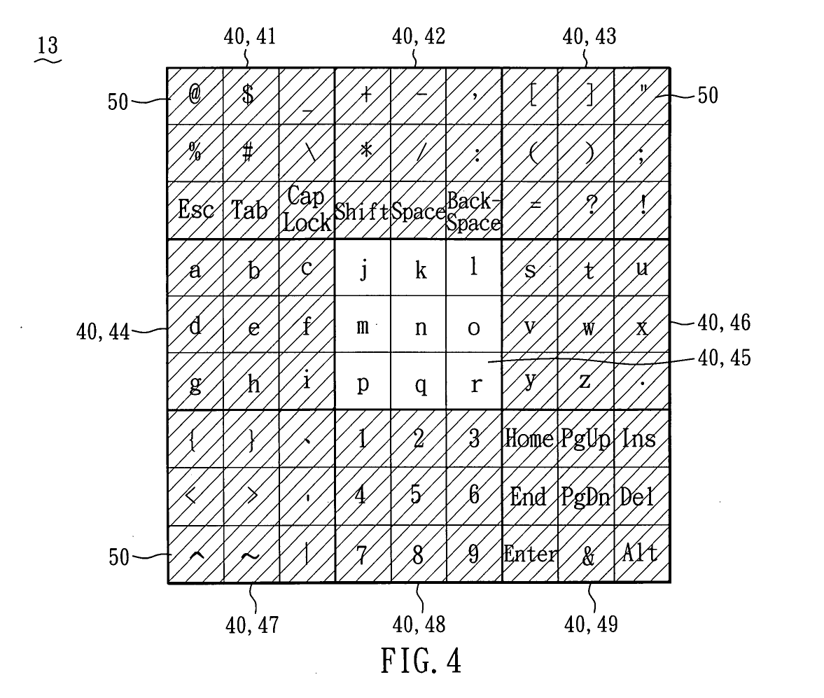

FIG. 4 is a schematic view of the nine-square virtual keyboard 13 according to a preferred embodiment of the invention. As shown in FIG. 4, the nine-square virtual keyboard 13 includes multiple subsidiary nine-square grids 40, specifically nine subsidiary nine-square grids 41-49 arranged in a 3×3 matrix form, each subsidiary nine-square grid 40 having multiple virtual keys 50, specifically nine virtual keys 50 arranged in a 3×3 matrix form. Each virtual key 50 corresponds to a predefined symbol or user option. The predefined symbol corresponding to the virtual key 50 can be an English letter, phonetic symbol, Chang Jei radical, Japanese phonetic alphabet, or special symbol. In other embodiments, the set of digit keys 210 can be replaced with a set of selection keys having any keys arranged in a 3×3 matrix form in order to correspond to the nine-square virtual keyboard. Namely, the set of selection keys are arranged in a 3×3 matrix as same as the set of digit keys 210 of the remote control 12 in order to easily select a virtual key 50 of a subsidiary nine-square grid.

There is a main-location subsidiary nine-square grid among the multiple subsidiary nine-square grids 40. In this embodiment, the subsidiary nine-square grid 45 is the main-location subsidiary nine-square grid. A highlight input focus is preset on the main-location subsidiary nine-square grid. The input focus is moved according to the operation of the remote control 12. In other embodiments, a specific color, fluorescent light, or flash manner can be used to display a subsidiary nine-square grid so as to indicate that the input focus is on the subsidiary nine-square grid.

By pressing the right direction key 231, up direction key 232, left direction key 233, and down direction key 234 of the remote control 12, the input focus can be set in another subsidiary nine-square grid 40. Namely, when the input focus is set in the subsidiary nine-square grid 40, the subsidiary nine-square grid 40 is displayed in highlight to emphasize the subsidiary nine-square grid 40, and also the set of digit keys 210 of the remote control 12 is pressed to select a virtual key of the subsidiary nine-square grid 40 with the input focus.

When the input function key 202 is enabled, the nine-square virtual keyboard 13 is displayed on the display device 11. For inputting a virtual key of the main-location subsidiary nine-square grid 45, the virtual key of the main-location subsidiary nine-square grid 45 is selected directly through pressing a corresponding key of the set of digit keys 210. For inputting a virtual key of other subsidiary nine-square grids 40, the input focus is moved to the desired subsidiary nine-square grid 40 by using the set of direction keys 231-234 , and the desired subsidiary nine-square grid 40 is displayed in highlight. Then, a corresponding key of the set of digit keys 210 is pressed to select the virtual key to be inputted, so as to input the symbol or user option corresponding to the virtual key selected. When the symbol or user option corresponding to the virtual key selected has been inputted, the input focus returns to the main-location subsidiary nine-square grid 45.

For example, for inquiring the name “razavi” as shown in FIG. 1, the digit key “9”, the left direction key 233 “←”, the digit key “1”, the right direction key 231 “→”, the digit key “8”, the left direction key 233 “←”, the digit key “1”, the right direction key 231 “→”, the digit key “4”, the left direction key 233 “←”, and the digit key “9” are sequentially inputted to complete the input of “razavi”.

There is one digit subsidiary nine-square grid 48 among the multiple subsidiary nine-square grids 40. The digit subsidiary nine-square grid 48 has the virtual keys of numbers 1-9. One or more numbers from one to nine can be selected from the digit subsidiary nine-square grid 48 by pressing the corresponding one or more keys of the set of digit keys 210 of the remote control 12, so as to complete a number input, except for the number zero which is obtained by directly pressing the digit key “0” of the remote control 12 to complete the “0” input.

When the digit of the digit subsidiary nine-square grid 48 corresponding to a selected virtual key is inputted, the input focus stays in the digit subsidiary nine-square grid 48. After the digit of the digit subsidiary nine-square grid 48 corresponding to the selected virtual key is inputted, the input focus returns to the main-location subsidiary nine-square grid 45 by pressing one of the direction keys 231-234 or the up direction key 232 “↑”.

For example, when “yes123” is desired to be inputted, the right direction key 231 “→”, the digit key “7”, the left direction key 233 “←”, the digit key “5”, the right direction key 231 “→”, and the digit key “1” are inputted to complete the input of “yes”, and the down direction key 234 “↓”, the digit key “1”, the digit key “2”, and the digit key “3” are inputted to complete the input of “123”, so as to obtain the desired input of “yes123”.

As shown in FIG. 4, the main-location subsidiary nine-square grid 45, its right-hand subsidiary nine-square grid 46, and its left-hand subsidiary nine-square grid 44 have virtual keys of the alphabets from “a” to “z” and the period sign “.”. The virtual keys “a” to “z” are arranged according to the usage probability, and in this case the first nine alphabet virtual keys with the highest usage probability are arranged in the main-location subsidiary nine-square grid 45. However, all alphabet virtual keys “a”-“z” can be arranged in the inherent alphabet sequence or in a PC keyboard sequence.

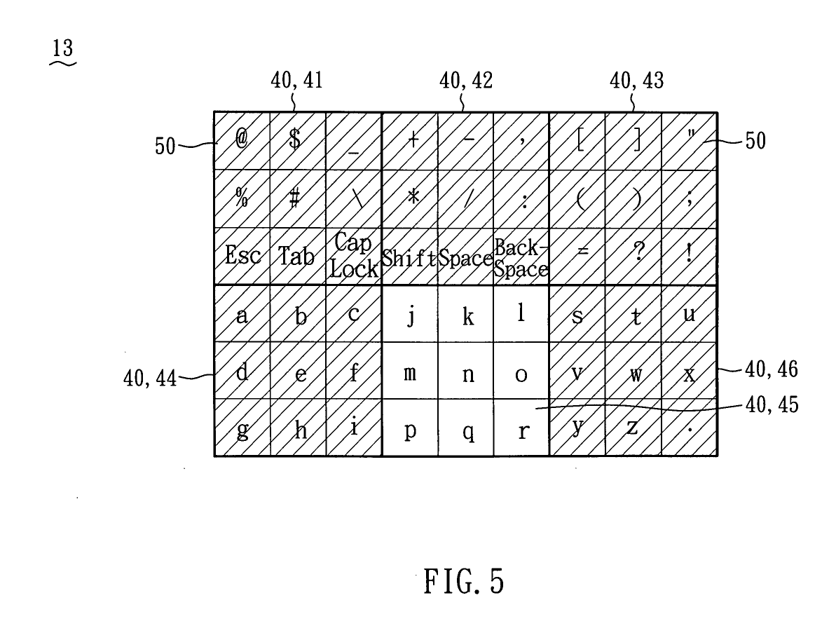

As shown in FIG. 4, the nine-square virtual keyboard 13 is comprised of 3×3 subsidiary nine-square grids 40. In order to reduce the used area of the nine-square virtual keyboard 13 on the display device 11, FIG. 5 illustrates a schematic view of another nine-square virtual keyboard 13 according to a preferred embodiment of the invention. As shown in FIG. 5, the nine-square virtual keyboard 13 is comprised of 2×3 subsidiary nine-square grids 40.

For either the nine-square virtual keyboard 13 shown in FIG. 4 or the nine-square virtual keyboard 13 shown in FIG. 5, the virtual keys “@”, “$”, “%”, and “#” are located in the first row, first column subsidiary nine-square gird 41 of the 3×3 or 2×3 subsidiary nine-square grids 40; the virtual keys “+”, “−”, “*”, and “/” are located in the first row, second column subsidiary nine-square grid 42 of the 3×3 or 2×3 subsidiary nine-square grids 40; and the virtual keys “[”, “]”, “(”, and “)” are located in the first row, third column subsidiary nine-square grid 43 of the 3×3 or 2×3 subsidiary nine-square grids 40. Such a virtual key arrangement allows a user to easily input a website address so as to increase the Internet surfing convenience. For example, for a website address input, the keys “@”, “$”, “%”, and “#” are frequently used, and thus they are located in the first row, first column subsidiary nine-square grid 41.

In addition, for the convenience of math calculation, the virtual keys “+”, “−”, “*”, and “/” are located in the first row, second column subsidiary nine-square grid 42, and the virtual keys “[”, “]”, “(”, and “)” are located in the first row, third column subsidiary nine-square grid 43. Also, the key “_” is located on the left side of the key “+” , and the key “−” is located on the right side of the key “+”, so as to form a sequence of “_”, “+”, and “−” thereby allowing the user to easily memorize. Similarly, the key “\” is located on the left side of the key “*”, and the key “/” is located on the right side of the key “*”, so as to form a sequence of “\”, “*”, and “/”. The virtual keys “=”, “?”, and “!” are located in the first row, third column subsidiary nine-square grid 43. The keys “Home”, “End”, “PgUp”, “PgDn” that are commonly used for a cursor or page control are located in the third row, third column subsidiary nine-square grid 49. The above arrangement of the virtual keys is based on easy memorization and convenient usage for a user so as to speed up an input.

When the nine-square virtual keyboard 13 is comprised of the 3×3 subsidiary nine-square grids 40, the main-location subsidiary nine-square grid 45 is the second row, second column subsidiary nine-square grid of the 3×3 subsidiary nine-square grids 40. When the input function key 202 is enabled, the 3×3 subsidiary nine-square grids 40 are displayed on the display device 11.

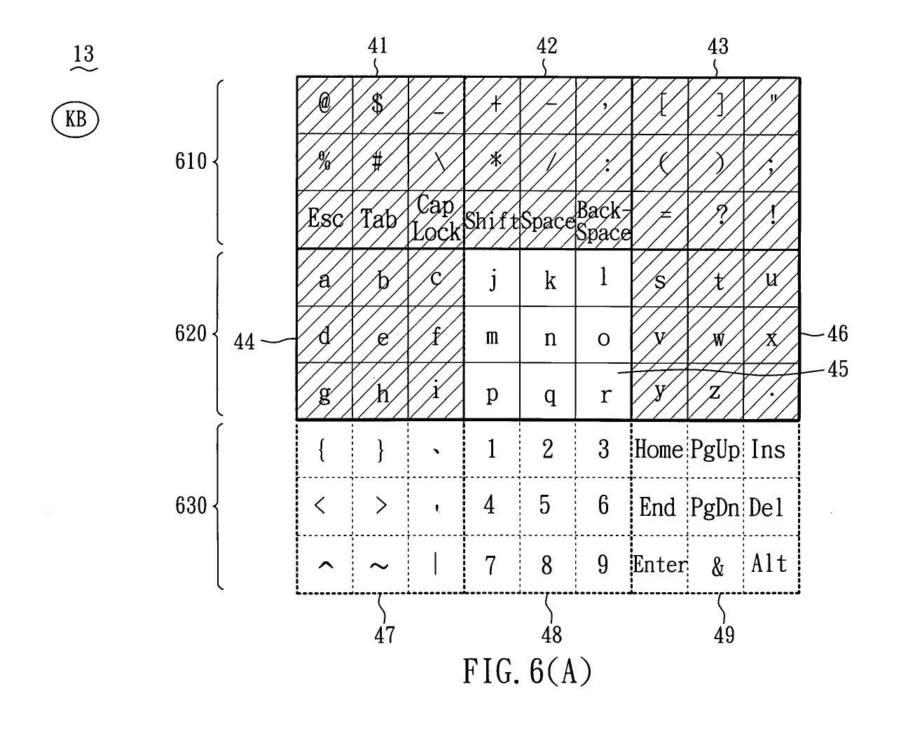

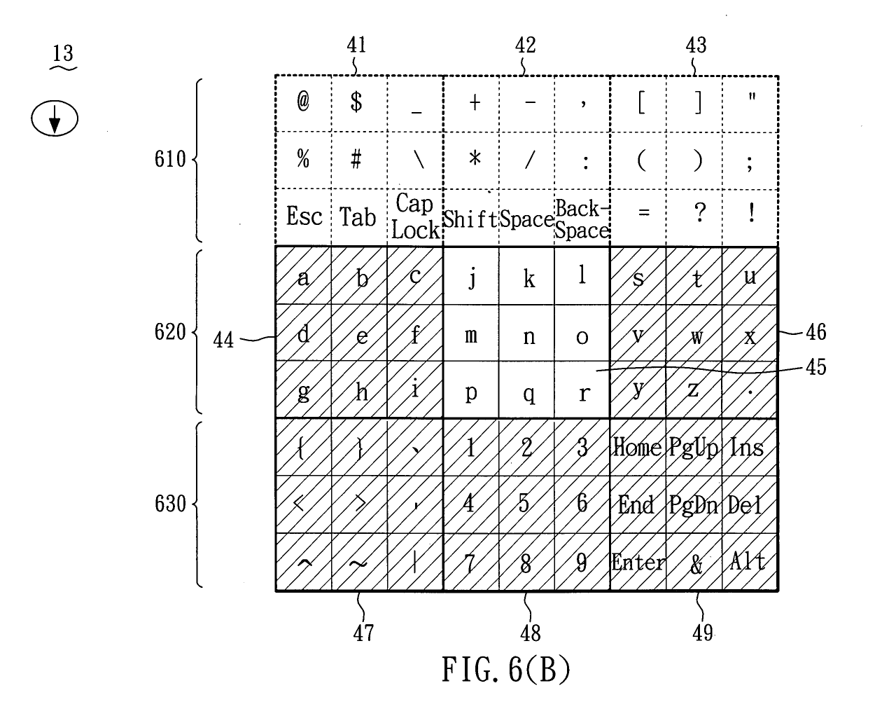

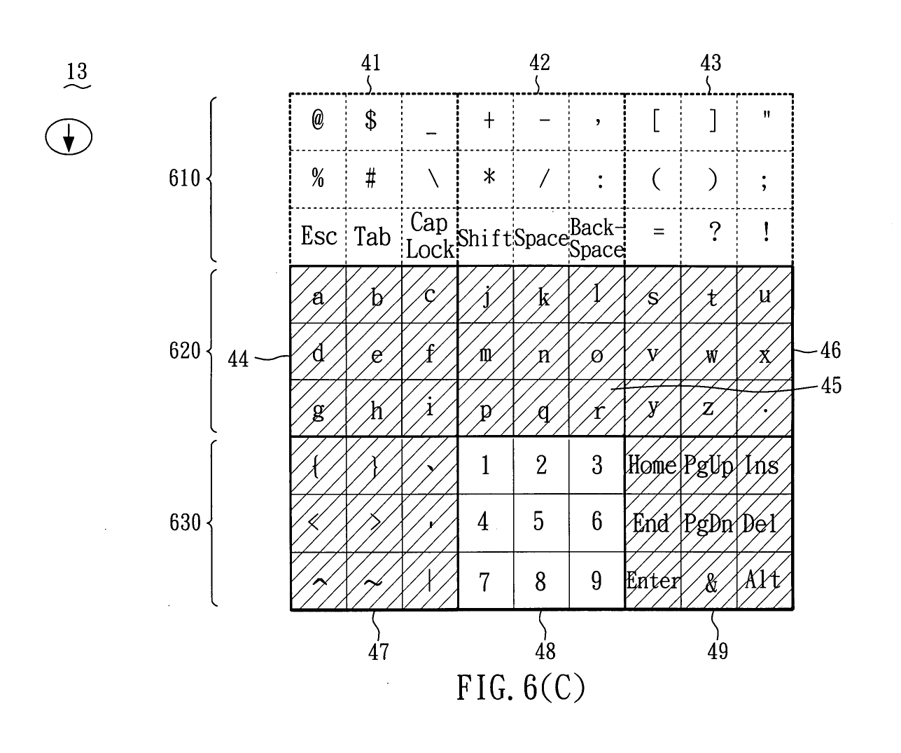

In other embodiments, in order to reduce the used area of the nine-square virtual keyboard 13 on the display device 11, the nine-square virtual keyboard 13 is still comprised of 3×3 subsidiary nine-square grids, but the 3×3 subsidiary nine-square grids are divided into a first-row subsidiary nine-square part 610 having three subsidiary nine-square grids 41, 42, 43 of first row, a second-row subsidiary nine-square part 620 having three subsidiary nine-square grids 44, 45, 46 of second row, and a third-row subsidiary nine-square part 630 having three subsidiary nine-square grids 47, 48, 49 of third row. The main-location subsidiary nine-square grid 45 is the second row, second column subsidiary nine-square grid of the 3×3 subsidiary nine-square grids. When the input function key 202 is enabled, the first-row subsidiary nine-square part 610 and second-row subsidiary nine-square part 620 of the 3×3 subsidiary nine-square grids 40 are displayed on the display device 11; i.e., only two rows of subsidiary nine-square grids are displayed, as shown in FIG. 6(A). In this case, the input focus is on the main-location subsidiary nine-square grid 45, while the third-row subsidiary nine-square part 630 is not displayed.

As shown in FIG. 6(B), when the down direction key 234, “↓”, is pressed, the second-row subsidiary nine-square part 620 and third-row subsidiary nine-square part 630 of the 3×3 subsidiary nine-square grids 40 are displayed on the display device 11, and the first-row subsidiary nine-square part 610 is invisible. In this case, the input focus is still on the main-location subsidiary nine-square grid 45. When the up direction key 232, “↑”, is pressed, or the down direction key 234, “↓”, is pressed again, the nine-square virtual keyboard 13 is displayed again as shown in FIG. 6(A).

In other embodiments, as shown in FIG. 6(C), when the down direction key 234, “↓”, is pressed, the second-row subsidiary nine-square part 620 and third-row subsidiary nine-square part 630 of the 3×3 subsidiary nine-square grids 40 are displayed on the display device 11, and the input focus is at the digit subsidiary nine-square grid 48.

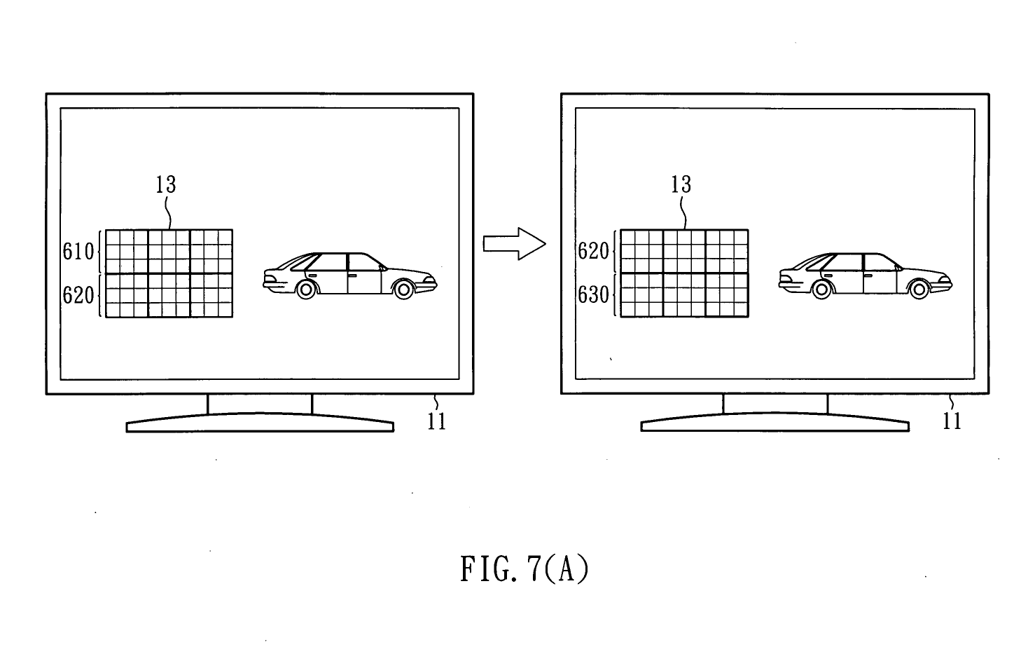

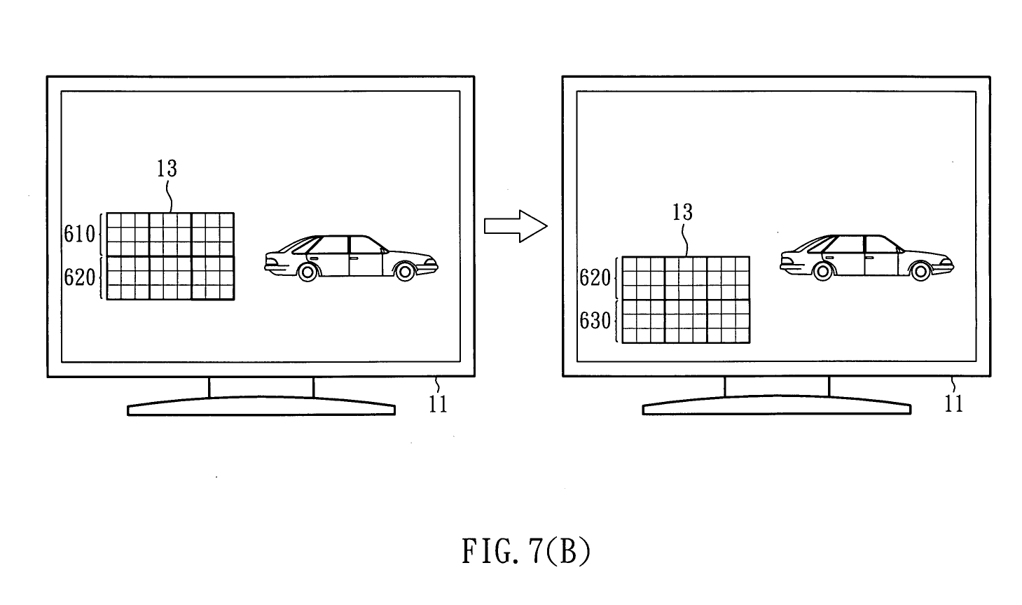

When the second-row subsidiary nine-square part 620 and third-row subsidiary nine-square part 630 of the 3×3 subsidiary nine-square grids 40 of FIGS. 6(A)-6(C) are displayed, as shown in FIG. 7(A), the second-row subsidiary nine-square part 620 is displayed on the location where the first-row subsidiary nine-square part 610 is displayed previously, and the third-row subsidiary nine-square part 630 is displayed on the location where the second-row subsidiary nine-square part 620 is displayed previously.

In other embodiments, as shown in FIG. 7(B), the second-row subsidiary nine-square part 620 is displayed at the same location, and the third-row subsidiary nine-square part 630 is displayed on a location below the displayed location of the second-row subsidiary nine-square part 620.

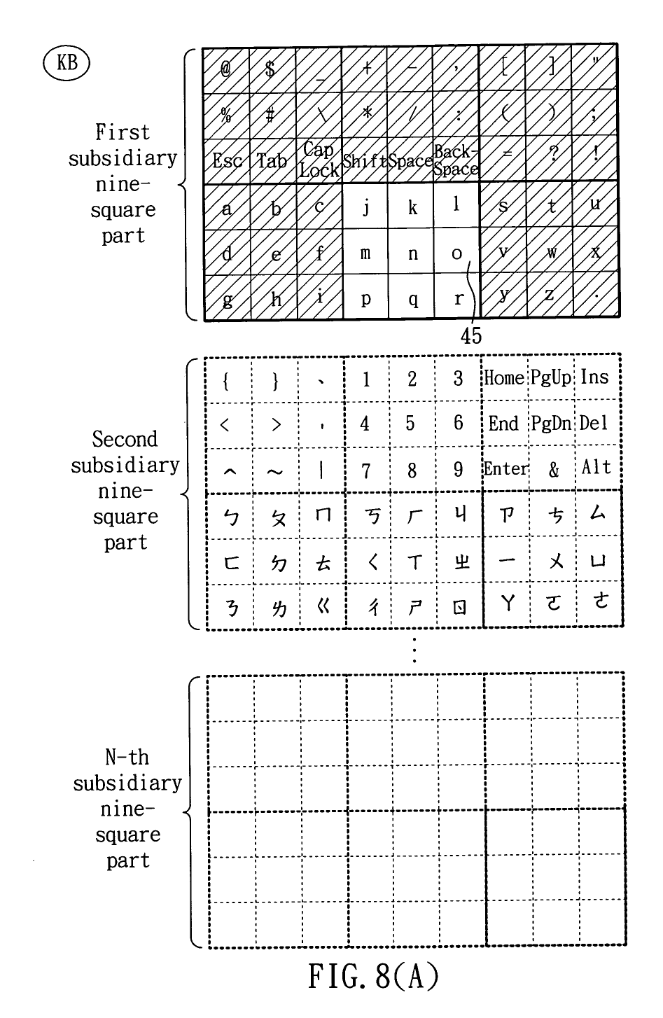

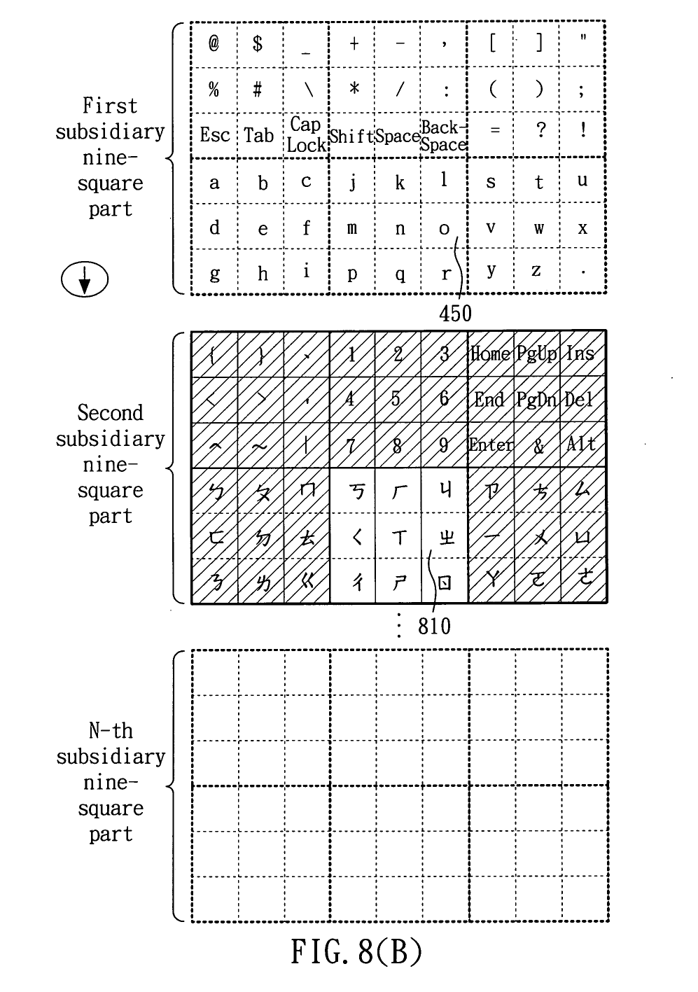

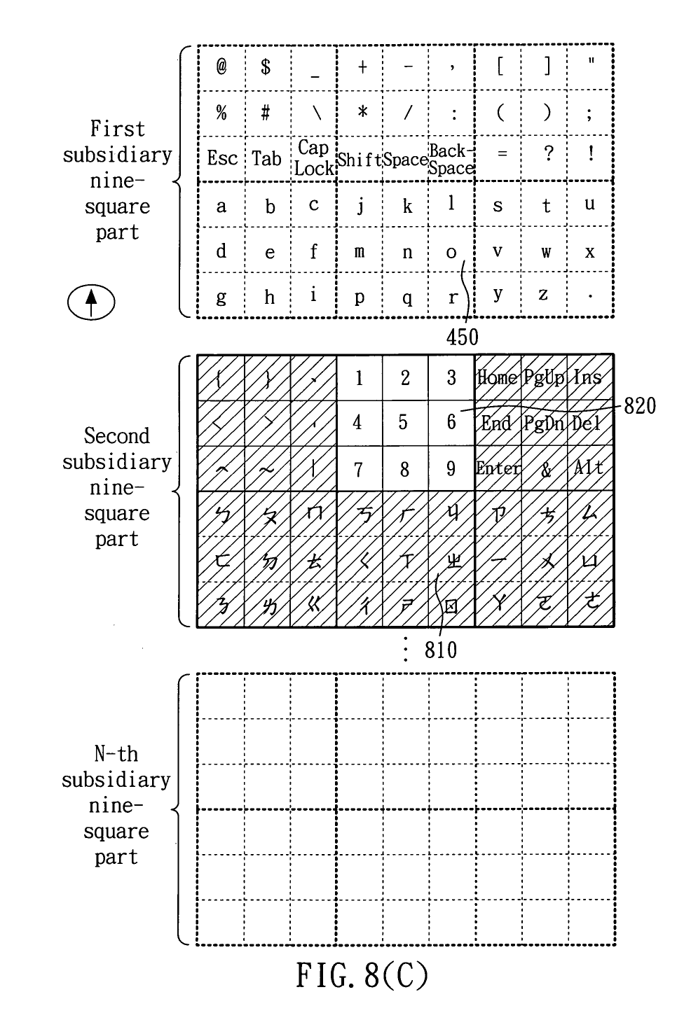

The nine-square virtual keyboard 13 can be comprised of N subsidiary nine-square parts, each having 2×3 subsidiary nine-square grids arranged in a 2×3 matrix form (where N is an integer greater than two). As shown in FIG. 8(A), when the input function key 202 is enabled, the input focus is at the second row, second column subsidiary nine-square grid 45 of the first subsidiary nine-square part, and the 2×3 subsidiary nine-square grids of the first subsidiary nine-square part are displayed on the display device 11. When the down direction key 234, “↓”, is pressed, the 2×3 subsidiary nine-square grids of the second subsidiary nine-square part are displayed on the display device 11. When the down direction key 234, “↓”, is pressed K times, the 2×3 subsidiary nine-square grids of the (K+1)-th subsidiary nine-square part are displayed on the display device 11, where 2≦K≦N−1. When the down direction key 234, “↓”, is pressed N times, the 2×3 subsidiary nine-square grids of the first subsidiary nine-square part are displayed on the display device 11 again.

As shown in FIG. 8(B), when the down direction key 234, “↓”, is pressed, the 2×3 subsidiary nine-square grids of the second subsidiary nine-square part are displayed on the display device 11, and the input focus is at the second row, second column subsidiary nine-square grid 810 of the second subsidiary nine-square part. As shown in FIG. 8(C), when the up direction key 232, “↑”, is pressed, the input focus is at the first row, second column subsidiary nine-square grid 820 of the second subsidiary nine-square part. When the up direction key 232, “↑”, is pressed again, the 2×3 subsidiary nine-square grids of the first subsidiary nine-square part are displayed, and the input focus is at the second row, second column subsidiary nine-square grid 45 of the first subsidiary nine-square part.

In this embodiment, when the predefined symbol or user option corresponding to a selected virtual key is inputted, the input focus returns to the main-location subsidiary nine-square grid 45. In other embodiments, when the predefined symbol or user option corresponding to a selected virtual key is inputted, the input focus stays at the same subsidiary nine-square grid without returning to the main-location subsidiary nine-square grid 45, which allows a user to conveniently select another symbol or user option from the same subsidiary nine-square grid. As cited, the nine-square virtual input system using a remote control can be implemented on an existing TV remote control, so as to reduce the cost and the number of pressing the input function key on the remote control, as compared with the prior art, thereby achieving a rapid input by means of the remote control and further increasing the user-friendliness of the human-machine interface.

Although the present invention has been explained in relation to its preferred embodiment, it is to be understood that many other possible modifications and variations can be made without departing from the spirit and scope of the invention as hereinafter claimed.

What is claimed is:

1. A nine-square virtual input system comprising:
a nine-square virtual keyboard including multiple subsidiary nine-square grids, each having multiple virtual keys, one of the subsidiary nine-square grids being a main-location subsidiary nine-square grid;
a display device for displaying the nine-square virtual keyboard; and
a remote control having an input function key, a set of direction keys, and a set of selection keys for remotely controlling the display device, the set of selection keys having multiple keys arranged in a 3×3 matrix form for corresponding to the nine-square virtual keyboard;
wherein the nine-square virtual keyboard is displayed on the display device when the input function key is enabled, a virtual key of the main-location subsidiary nine-square grid is inputted by directly using the set of selection keys to select the virtual key of the main-location subsidiary nine-square grid, and a virtual key of a desired one among the other subsidiary nine-square grids is inputted by using the set of direction keys to move to the desired subsidiary nine-square grid and using the set of selection keys to select the virtual key of the desired subsidiary nine-square grid, thereby inputting a predefined symbol or user option corresponding to the virtual key selected.

2. The nine-square virtual input system as claimed in claim 1, wherein the set of selection keys includes a set of digit keys, and an input focus is preset on the main-location subsidiary nine-square grid and is moved with operation of the remote control.

3. The nine-square virtual input system as claimed in claim 2, wherein the input focus returns to the main-location subsidiary nine-square grid after the predefined symbol or user option corresponding to the virtual key selected is inputted.

4. The nine-square virtual input system as claimed in claim 3, wherein one of the subsidiary nine-square grids is a digit subsidiary nine-square grid which has virtual keys corresponding to numbers from one to nine.

5. The nine-square virtual input system as claimed in claim 4, wherein the input focus stays at the digit subsidiary nine-square grid when inputting a number corresponding to a virtual key selected from the digit subsidiary nine-square grid.

6. The nine-square virtual input system as claimed in claim 5, wherein after the number corresponding to the virtual key selected from the digit subsidiary nine-square grid is inputted, the input focus returns to the main-location subsidiary nine-square grid by pressing any key of the set of the direction keys.

7. The nine-square virtual input system as claimed in claim 2, wherein the main-location subsidiary nine-square grid, its right-hand subsidiary nine-square grid, and its left-hand subsidiary nine-square grid have the virtual keys of alphabets from “a” to “z” and period sign “.”.

8. The nine-square virtual input system as claimed in claim 7, wherein the virtual keys of alphabets from “a” to “z” are arranged according to usage probability.

9. The nine-square virtual input system as claimed in claim 8, wherein the first nine virtual keys of alphabets from “a” to “z” with the highest usage probability are arranged in the main-location subsidiary nine-square grid.

10. The nine-square virtual input system as claimed in claim 7, wherein the virtual keys of alphabets from “a” to “z” are arranged in an inherent alphabet sequence.

11. The nine-square virtual input system as claimed in claim 7, wherein the virtual keys of alphabets from “a” to “z” are arranged in a personal computer keyboard sequence.

12. The nine-square virtual input system as claimed in claim 6, wherein the nine-square virtual keyboard is comprised of J×3 subsidiary nine-square grids and virtual keys of “@”, “$”, “%”, and “#” are located in the first row, first column subsidiary nine-square grid of the J×3 subsidiary nine-square grids, where J=2 or J=3.

13. The nine-square virtual input system as claimed in claim 12, wherein the nine-square virtual keyboard has virtual keys of “+”, “−”, “*”, and “/” located in the first row, second column subsidiary nine-square grid of the J×3 subsidiary nine-square grids.

14. The nine-square virtual input system as claimed in claim 13, wherein the nine-square virtual keyboard has virtual keys of “[”, “]”, “(”, and “)” located in the first row, third column subsidiary nine-square grid of the J×3 subsidiary nine-square grids.

15. The nine-square virtual input system as claimed in claim 6, wherein the nine-square virtual keyboard is comprised of 3×3 subsidiary nine-square grids, the main-location subsidiary nine-square grid is at the second row, second column of the 3×3 subsidiary nine-square grids, and the 3×3 subsidiary nine-square grids are displayed on the display device when the input function key is enabled.

16. The nine-square virtual input system as claimed in claim 6, wherein the nine-square virtual keyboard is comprised of 3×3 subsidiary nine-square grids, the main-location subsidiary nine-square grid is at the second row, second column of the 3×3 subsidiary nine-square grids, and the first and second rows of the 3×3 subsidiary nine-square grids are displayed on the display device when the input function key is enabled.

17. The nine-square virtual input system as claimed in claim 16, wherein the second and third rows of the 3×3 subsidiary nine-square grids are displayed on the display device and the first row of the 3×3 subsidiary nine-square grids is invisible when a down direction key of the set of direction keys is pressed.

18. The nine-square virtual input system as claimed in claim 17, wherein the second row of the 3×3 subsidiary nine-square grids is displayed on a location where the first row of the 3×3 subsidiary nine-square grids is displayed previously, and the third row of the 3×3 subsidiary nine-square grids is displayed on a location where the second row of the 3×3 subsidiary nine-square grids is displayed previously.

19. The nine-square virtual input system as claimed in claim 17, wherein the second row of the 3×3 subsidiary nine-square grids is displayed on a same location, and the third row of the 3×3 subsidiary nine-square grids is displayed on a location below the second row of the 3×3 subsidiary nine-square grids.

20. The nine-square virtual input system as claimed in claim 6, wherein the nine-square virtual keyboard is comprised of N subsidiary nine-square parts, each having 2×3 subsidiary nine-square grids, the main-location subsidiary nine-square grid is a second row, second column subsidiary nine-square grid of a subsidiary nine-square part, and a first subsidiary nine-square part is displayed on the display device when the input function key is enabled, where N is an integer greater than two.

21. The nine-square virtual input system as claimed in claim 20, wherein a second subsidiary nine-square part is displayed on the display device when a down direction key of the set of direction keys is pressed, a (K+1)-th subsidiary nine-square part is displayed on the display device when the down direction key is pressed K times, where 2≦K≦N−1, and the first subsidiary nine-square part is displayed on the display device when the down direction key is pressed N times.
